(19) United States
(12) Patent Application Publication
(10) Pub. No.: US 2014/0184776 A1
(43) Pub. Date: Jul. 3, 2014

(54) MICRO OR NANO SCOPE

(71) Applicant: ELECTRONICS AND TELECOMMUNICATIONS RESEARCH INSTITUTE, Daejeon (KR)

(72) Inventor: Hyeon-Bong PYO, Daejeon (KR)

(73) Assignee: ELECTRONICS AND TELECOMMUNICATIONS RESEARCH INSTITUTE, Daejeon (KR)

(21) Appl. No.: 14/063,492

(22) Filed: Oct. 25, 2013

(30) Foreign Application Priority Data
Dec. 28, 2012 (KR) 10-2012-0156264

(51) Int. Cl. G02B 21/08; G01Q 60/18; G01Q 60/10; G02B 21/36

(52) U.S. Cl. CPC G02B 21/084; G02B 21/361; G01Q 60/18; G01Q 60/10
USPC 348/79

(57) ABSTRACT

Provided is a micro or nano scope. The micro or nano scope includes a prism, a optical detection system detecting an image from a sample on the prism, and a light guiding system providing incident light to the prism, the light guiding system changing an incident angle of the incident light incident into the prism.

### CROSS-REFERENCE TO RELATED APPLICATIONS

This U.S. non-provisional patent application claims priority under 35 U.S.C. § 119 of Korean Patent Application No. 10-2012-0156264, filed on Dec. 28, 2012, the entire contents of which are hereby incorporated by reference.

### BACKGROUND OF THE INVENTION

The present invention disclosed herein relates to an optical measuring device, and more particularly, to a micro or nano scope such as a dark-field imaging microscope, a photon scanning-tunneling microscope (PSTM), or a near-field scanning optical microscope (NSOM/SNOM).

In general, optical microscopes, PSTMs, and NSOM/SNOMs may detect dark-field images. Such a dark-field image may reduce a background signal and have a high signal-to-noise ratio (SNR), i.e., a high contrast ratio when compared to a normal image. The dark-field image may be acquired when a numerical aperture (NA) of light source emitted onto a sample is greater than that of an objective lens. Here, most of the light emitted from the light source onto the sample may not be transferred into the objective lens.

In a general dark-field image method, incident light is tailored in a halo shape by using a path stop that covers a portion of the incident light. The incident angle of light is determined by a diameter of the patch stop. Thus, an NA of incident optics may be determined by a reflective index of a condenser lens and the diameter, i.e., a size of the patch stop. If it is intended to change the NA of the incident optical system by a user, the size of the patch stop or the reflective index of the condenser lens should be changed. It is therefore desirable to change numerical aperture (NA) of incident optics without replacing the condenser or patch stop, as by changing the angle of incidence continuously.

### SUMMARY OF THE INVENTION

The present invention provides a micro or nano scope which is capable of changing the angle of incidence of light provided into a prism.

The present invention also provides a micro or nano scope which is capable of successive changes of the NA of incident optics.

The feature of the present invention is not limited to the aforesaid, but other features not described herein will be clearly understood by those skilled in the art from descriptions below.

Embodiment of the inventive concept provide micro or nano scopes including: a prism; an optical detection system detecting an image from a sample on the prism; and a light guiding system providing incident light into the prism and changing an angle of incidence of light.

In some embodiments, the light guiding system may include: a light source part providing the incident light to the prism; a source light detection part detecting light reflected by the prism from the incident light; and a goniometer adjusting the angle of incidence of light from the light source part into the prism.

In other embodiments, the goniometer may include: a central shaft disposed under the prism and spaced apart from the prism; a plurality of arms connected to the central shaft; and a plurality of holders connected to the light source part together with one of the plurality of arms and connected to the source light detection part together with the other one of the plurality of arms.

In still other embodiments, the light guiding system may further include a rail disposed under the prism the light guiding system restricting movement of the central shaft.

In even other embodiments, the light source part may include: a light source supplying the incident light; a collimator collimating the incident light generated in the light source; a filter filtering or polarizing the incident light collimated by the collimator; and an incident mirror providing the incident light into the prism.

In yet other embodiments, the light source may include a gas laser, a semiconductor laser, a laser diode, a halogen lamp, a xenon lamp, or a white light emitting diode.

In further embodiments, the collimator may include a plurality of lenses.

In still further embodiments, the source light detection part may include: a detection mirror reflecting the light reflected from the prism; and a detection device detecting the light reflected from the detection mirror.

In even further embodiments, the detection device may include a photodiode or a CCD(Charge Coupled Device).

In yet further embodiments, the prism may have a triangular shape, a hemi-cylindrical shape, a hemi-spherical shape, or a dove shape.

In much further embodiments, the prism may have a refractive index of about 1.4 to about 1.9.

In still much further embodiments, the glass may include at least one of silica (n=1.459), BK7 (n=1.517), SF10 (n=1.728), SF11 (n=1.784), and NaSF N9 (n=1.850).

In even much further embodiments, the optical detection system may include: an objective lens on the prism; at least one lens holder on the objective lens; at least one ocular lens on the lens holder; and an imaging device or an optical fiber coupler on the ocular lens.

In yet much further embodiments, the imaging device may include a charge coupled device (CCD) or a CMOS image sensor.

In yet much still further embodiments, when each of the lens holder and the ocular lens is provided in plurality, the optical detection system may further include a translation stage disposed between the objective lens and the plurality of lens holders.

### BRIEF DESCRIPTION OF THE DRAWINGS

The accompanying drawings are included to provide a further understanding of the present invention, and are incorporated in and constitute a part of this specification. The drawings illustrate exemplary embodiment of the inventive concept and, together with the description, serve to explain principles of the present invention. In the drawings:

FIG. 1 is a cross-sectional view of a micro or nano scope according to an embodiment of the inventive concept;

FIG. 2 is an enlarged view of a prism, a sample, and an objective lens of FIG. 1; and

FIG. 3 is a cross-sectional view of a micro or nano scope according to an exemplary embodiment of the inventive concept.

### DETAILED DESCRIPTION OF PREFERRED EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the drawings, the dimensions of layers and regions are exaggerated for clarity of illustration.

In the following description, the technical terms are used only for explain a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Additionally, the embodiment in the detailed description will be described with sectional views as ideal exemplary views of the present invention. In the figures, the dimensions of layers and regions are exaggerated for clarity of illustration. Accordingly, shapes of the exemplary views may be modified according to manufacturing techniques and/or allowable errors. Therefore, the embodiment of the inventive concept are not limited to the specific shape illustrated in the exemplary views, but may include other shapes that may be created according to manufacturing processes. For example, an etched region illustrated or described as a rectangle will, typically, have rounded or curved features. Thus, the regions illustrated in the figures are schematic in nature and their shapes are not intended to illustrate the precise shape of a region of a device and are not intended to limit the scope of the present invention.

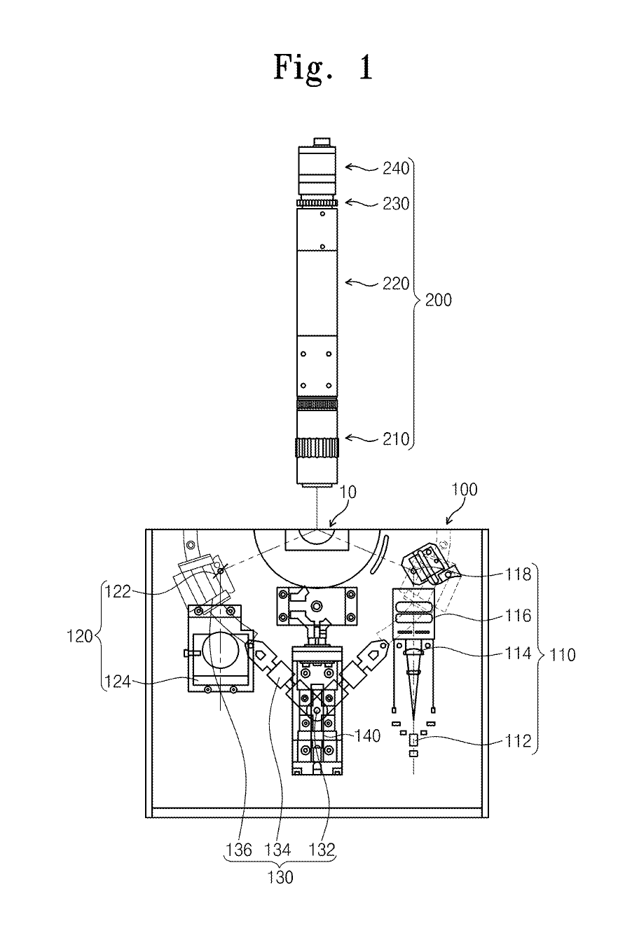

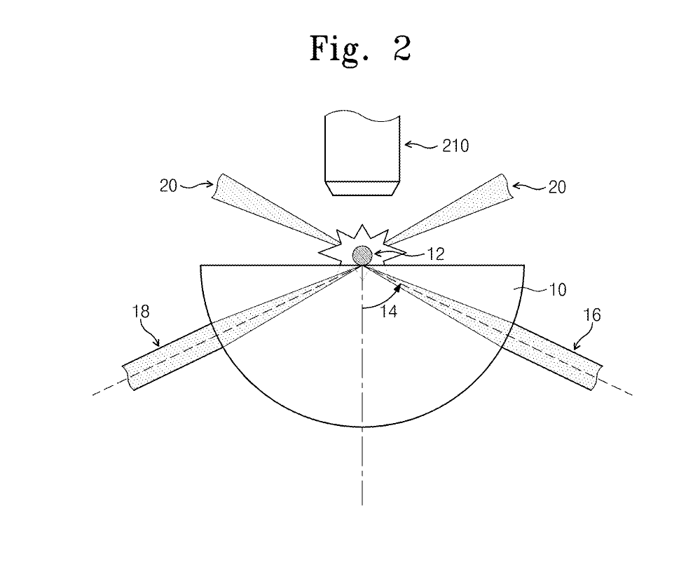

FIG. 1 is a cross-sectional view of a micro or nano scope according to an embodiment of the inventive concept. FIG. 2 is an enlarged view of a prism 10, a sample 12, and an objective lens 210 of FIG. 1.

Referring to FIGS. 1 and 2, the micro or nano scope according to the present invention may include the prism 10, an optical detection system 200, and a light guiding system 100.

The sample 12 may be disposed on the prism 10. The prism 10 may support the sample 12. The sample 12 may be nano particles. The prism 10 may include a glass having a refractive index of about 1.4 to about 1.9. For example, the glass prism may be made of silica (n=1.459), BK7 (n=1.517), SF10 (n=1.728), SF11 (n=1.784), or NaSF N9 (n=1.850). Also, the prism 10 may have a triangular shape, a hemi-cylindrical shape, a hemi-spherical shape, or a dove shape. The light guiding system 100 may provide incident light 16 to the prism 10. The prism 10 may reflect the incident light 16 into the light guiding system 100. The incident light 16 may be refracted in the prism 10.

The optical detection system 200 may detect the incident light 16 scattered from the sample 12. The optical detection system 200 may include an objective lens 210, a lens holder 220, an ocular lens 230, and an imaging device 240. The objective lens 210 may be disposed close to the sample 12. The lens holder 220 may hold the objective lens 210 and the ocular lens 230 above the sample 12. The objective lens 210 may provide an enlarged scattering image from the sample to the imaging device 240. The ocular lens 230 may be disposed on an upper end of the lens holder 220. The imaging device 240 may include a charge coupled device (CCD) or a CMOS image sensor. The images from sample 12 may be enlarged according to magnifications of the objective lens 210 and the ocular lens 230 and a distance between the objective lens 210 and the ocular lens 230. The optical detection system 200 may include a dark-field imaging microscope, or a near-field nano scope. The micro or nano scope may detect a far-field or near-field image or spectrum from the sample 12. The near-field microscope and the nano scope may include a cantilever tip or a xyz-piezo stage.

The light guiding system 100 may include a light source part 110, a source light detection part 120, and a goniometer 130. The light source part 110 may include a light source 112, a collimator 114, a filter 116, and an incident mirror.

The light source 112 may generate monochromatic or polychromatic incident light 16. For example, a gas laser, a semiconductor laser, or a laser diode may provide monochromatic incident light 16. a halogen lamp, a xenon lamp, or a white light emitting diode may provide polychromatic incident light 16. The light source 112 provides the incident light 16 to the prism. The collimator 114 may be disposed between the light source 112 and the incident mirror 118. The incident light 16 provided from the light source 112 may be collimated into expanded parallel light by the collimator 114. The collimator 114 may include a plurality of lenses. The filter 116 may include a chromatic filter or a polarizer. The chromatic filter may filter the polychromatic incident light 16 into the monochromatic incident light 16. The polarizer may linearly polarize or elliptically polarize the incident light 16. The incident mirror 118 may reflect the incident light 16 into the prism 10.

The source light detection part 120 may include a detection mirror 122 and a light detection device 124. The detection mirror 122 may again reflect light 18 reflected from the prism 10 onto the light detection device 124. The light detection device 124 may monitor the reflected light 18. The light detection device 124 may include a photodiode.

The goniometer 130 may include a central shaft 132, a plurality of arms 134, and holders 136. The central shaft 132 may fix the arms 134. The arms 134 may be disposed between the central shaft 132 and the holders 136. The holders 136 may be connected to the light source part 110 and the source light detection part 120, respectively. The central shaft 132 may be elevated along a rail 140. The rail 140 may be disposed under the prism 10. The central shaft 132 may be away from or close to the prism 10. The central shaft 132 adjusts an angle between the plurality of arms 134. As the central shaft 132 moves, a distance between the light source part 110 and the source light detection part 120 may vary. Here, the holders 136 may move along a track (not shown) spaced a predetermined distance from the prism 10. Even though the distance between the light source part 110 and the source light detection part 120 is changed, the light source part 110 may always provide the incident light 16 to the prism 10 and the sample 12. That is, an incident angle 14 of the incident light 16 may change.

When distance between the central shaft 132 and the prism 10 decreases, the incident angle 14 of the incident light 16 may increase. On the other hand, when the distance between the central shaft 132 and the prism 10 increases, the incident angle 14 of the incident light 16 may decrease. A numerical aperture (NA) of the light guiding system 100 may be changed according to the incident angle 14 of the incident light 16. Thus, the goniometer 130 may successively adjust the NA of incident optics.

The optical detection system 200 may acquire the dark-filed image, when total internal reflection of the incident light 16 takes place from the prism 10 and a NA of the light guiding system 100 is greater than that of the objective lens 210. When the incident light 16 is totally internally reflected on the prism 10, the dark-field image may be acquired by the sample 12 which is located in an evanescent field occurring on top of the prism surface 10. The incident light 16 may be absorbed or scattered by the sample 12 located in the evanescent field The incident light 16 absorbed or scattered by the sample 12 may be eventually viewed as a sample image on the objective lens 210.

When an incident angle 14 of the incident light 16 in the prism 10 is greater than a critical angle θ_{c}, a refracted light 20 refracted by the prism 10 may substantially disappear, and only an evanescent field bound on the surface of the prism 10 exists. The light guiding system 100 may totally internally reflect the incident light 16 into the prism 10. The light source part 110 may be adjusted at an angle greater than a critical angle θ_{c} of internal reflection of the incident light 16.

When the NA of the objective lens 210 is less than that of the prism 10, the refracted light 20 in the sample 12 may be selectively detected on the objective lens 210. The NA of the prism 10 may be determined by a refractive index of the prism 10 and an incident angle 14 of the incident light 16. Here, the NA of the prism 10 may be changed in proportion to the incident angle 14 of the incident light 16. For example, the goniometer 130 may have a maximum driving angle θₘₐₓ of about 70°. Thus, the incident light 16 may have an incident angle 14 from the critical angle θ_{c} to the maximum driving angle θₘₐₓ of the goniometer 130 (θ_{c},<θ<θₘₐₓ). The prism 10 formed of the BK7(n_{D}=1.517) material may have a critical angle of about 41.3° with respect to the incident light 16 of a He-Ne laser light (λ=632.8 nm). If it is assumed that the goniometer 130 has a maximum driving angle θₘₐₓ of about 70°, an angle driving range of the incident light 16 may become to a range of about 41.3°<θ<70°.

As described above, the goniometer 130 may adjust an incident angle 14 of the incident light 16 to successively change the NA of the prism 10. The micro or nano scope according to an embodiment of the inventive concept may include a dark-field imaging microscope, a photon scanning-tunneling microscope (PSTM), or a near-field scanning optical microscope (NSOM/SNOM).

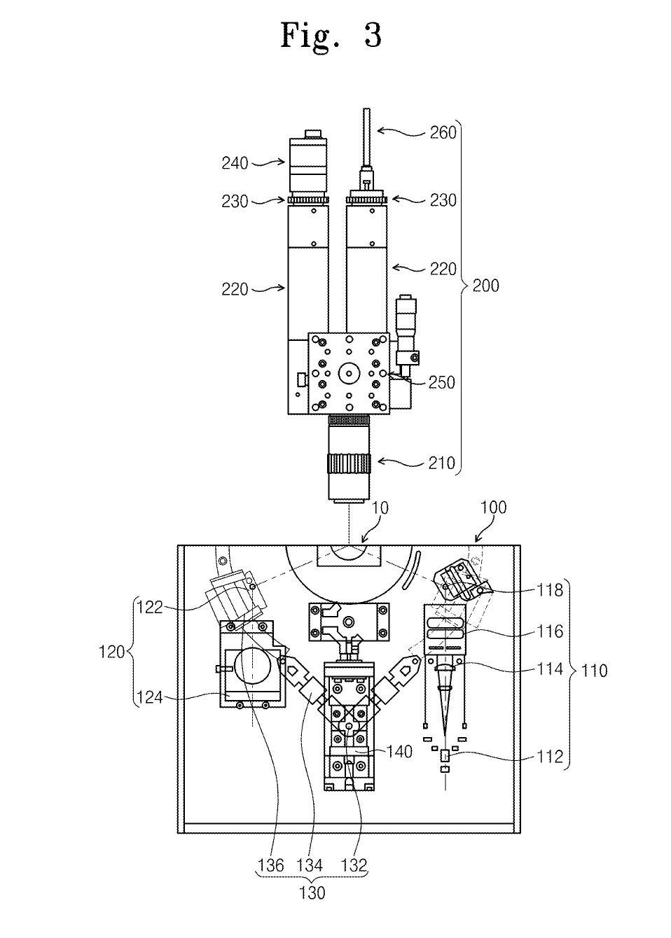

FIG. 3 is a cross-sectional view of a micro or nano scope according to an exemplary embodiment of the inventive concept.

Referring to FIG. 3, a micro or nano scope according to an exemplary embodiment of the inventive concept may include an optical detection system 200 including an objective lens 210, a translation stage 250, a plurality of lens holders 220, a plurality of ocular lenses 230, an imaging device 240, and an optical fiber coupler 260. The translation stage 250 may connect the plurality of lens holders 220 to the objective lens 210 in parallel. The plurality of lens holders 220 may hold the plurality of ocular lenses 230. The plurality of ocular lenses 230 may be connected to the imaging device 240 and the optical fiber coupler 260, respectively. The imaging device 240 may electrically transmit an image signal. The optical fiber coupler 260 may transmit an optical signal to the outside through an optical fiber 270.

Although not shown, the optical fiber 270 may be connected to an external spectrometer. The optical detection system 200 according to the exemplary embodiment of the inventive concept may further include the translation stage 250, the lens holders 220, the ocular lenses 230, and the optical fiber coupler 260 which are connected to each other in parallel in addition to the optical detection system according to the foregoing embodiment of the inventive concept.

The micro or nano scope according to the embodiment of the inventive concept may include the prism, the light guiding system, and the optical detection system. The light guiding system may include the light source part, the source light detection part, and the goniometer. The light source part may provide the incident light onto the prism. The goniometer may change a distance between the light source part and the source light detection part to change the incident angle of the incident light incident into the prism.

Thus, the micro or nano scope according to the embodiment of the inventive concept may successively change the NA of the prism.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A micro or nano scope comprising:
a prism;
an optical detection system detecting an image from a sample on the prism; and
a light guiding system providing incident light into the prism, the light guiding system changing an incident angle of the incident light.

2. The micro or nano scope of claim 1, wherein the light guiding system comprises:
a light source part providing the incident light to the prism;
a source light detection part detecting reflected light reflected by the prism from the incident light; and
a goniometer adjusting an incident angle of the incident light from the light source part to the prism.

3. The micro or nano scope of claim 2, wherein the goniometer comprises:
a central shaft disposed under the prism and spaced apart from the prism;
a plurality of arms connected to the central shaft; and
a plurality of holders connected to the light source part together with one of the plurality of arms and connected to the source light detection part together with the other one of the plurality of arms.

4. The micro or nano scope of claim 3, wherein the light guiding system further comprises a rail disposed under the prism, the rail restricting movement of the central shaft.

5. The micro or nano scope of claim 2, wherein the light source part comprises:
a light source supplying the incident light;
a collimator collimating the incident light generated in the light source;
a filter filtering or polarizing the incident light collimated by the collimator; and
an incident mirror providing the incident light into the prism.

6. The micro or nano scope of claim 5, wherein the light source comprises a gas laser, a semiconductor laser, a laser diode, a halogen lamp, a xenon lamp, or a white light emitting diode.

7. The micro or nano scope of claim 5, wherein the collimator comprises a plurality of lenses.

8. The micro or nano scope of claim 2, wherein the source light detection part comprises:
a detection mirror reflecting the light reflected from the prism; and
a detection device detecting the light reflected from the detection mirror.

9. The micro or nano scope of claim 8, wherein the detection device comprises a photodiode or a CCD(Charge Coupled Device).

10. The micro or nano scope of claim 1, wherein the prism has a triangular shape, a hemi-cylindrical shape, a hemi-spherical shape, or a dove shape.

11. The micro or nano scope of claim 1, wherein the prism has a refractive index of about 1.4 to about 1.9.

12. The micro or nano scope of claim 11, wherein the glass comprises at least one of silica (n=1.459), BK7 (n=1.517), SF10 (n=1.728), SF11 (n=1.784), and NaSF N9 (n=1.850).

13. The micro or nano scope of claim 1, wherein the optical detection system comprises:
an objective lens on the prism;
at least one lens holder on the objective lens;
at least one ocular lens on the lens holder; and
an imaging device or an optical fiber coupler on the ocular lens.

14. The micro or nano scope of claim 13, wherein the imaging device comprises a charge coupled device (CCD) or a CMOS image sensor.

15. The micro or nano scope of claim 13, wherein the optical detection system further comprises a translation stage disposed between the objective lens and the plurality of lens holders, when each of the lens holder and the ocular lens is provided in plurality,.
